(19) United States
(12) Patent Application Publication
(10) Pub. No.: US 2008/0012358 A1
(43) Pub. Date: Jan. 17, 2008

(54) Sweep lock

(76) Inventors: Luke Liang, Irvington, NJ (US); David Cheng, Guangzhou (CN); Toni Liang, Guangzhou (CN)

Correspondence Address: Thomas A. O'Rourke;Bodner & O'Rourke, 425 Broadhollow Road, Melville, NY, 11747, US

(21) Appl. No.: 11/810,139

(22) Filed: Jun. 4, 2007

Related U.S. Application Data
(60) Provisional application No. 60/812,217, filed on Jun. 9, 2006.
(60) Provisional application No. 60/810,616, filed on Jun. 2, 2006.

(51) Int. Cl. E05C 3/04

(52) U.S. Cl. 292/241

(57) ABSTRACT

There is a sweep lock having a housing with a sweep connected to the bottom surface of the housing. The sweep has a handle portion and a tongue portion, and is adapted to move from a first position to a second position, whereby said tongue is in an extended position in one of said first and second positions. The housing has a spring means having first and second ends. The first end is secured to the housing, and the second end is secured to the sweep.

This application claims priority on U.S. Provisional Patent Application Ser. No. 60/812,217 filed Jun. 9, 2006 and U.S. Provisional Patent Application Ser. No. 60/810,616 filed Jun. 2, 2006, the disclosures of which are incorporated herein by reference.

### FIELD OF THE INVENTION

The present invention relates to sash locks for double hung windows and the like. In particular, the present invention relates to sweep locks for windows. More particularly, the present invention relates to stamped locks as opposed to locks made from casting.

### BACKGROUND OF THE INVENTION

Sash locks are very common in many window applications. Most double hung windows use a sash lock for security purposes, as well as to keep the upper sash from dropping down in the window. Double hung windows were originally designed to provide better ventilation than other windows. In operation, hot air was supposed to leave a room from the upper window where the window was opened. Cool air was to enter through the lower window opening.

Most sash locks currently used in windows have a housing with three orifices present. The first orifice or center orifice is for the stem of a handle. The handle is positioned on the outer surface of the housing and has a stem that passes through the center opening in the housing and has a tongue or cam on its opposite end. There are two other openings in the housing besides the center opening. These two other openings are for securing the sash lock to a window. A screw or other security means passes through the housing and enters the wood, metal or plastic of the window sash.

Because of an increase in metal costs, there are a number of efforts to reduce material costs in sash locks. One approach has been to eliminate cast metal from the sash lock and use a plastic or a metal stamping or a combination metal and plastic stamping. This reduces not only the cost but also the amount of time it takes to manufacture a sash lock. Other efforts are also being made to reduce the costs of sash locks.

Most double hung windows have a first sash and a second sash. The sashes travel in a pair of tracks in a frame. The sash lock has a locking mechanism and a keeper. A tongue extends from the locking mechanism to the keeper to prevent the sashes from moving and thus opening the window. In some applications a keeper can be eliminated and the tongue prevents movement of the sash. The locks used in these applications are called sweep locks and can be secured, for example, to a keeper or to an orifice in the frame holding the window.

### OBJECTS OF THE INVENTION

It is an object of the present invention to provide an improved sash lock.

It is also an object of the invention to provide a unique sash lock from a stamping such as a metal or plastic stamping.

It is another object of the invention to provide a sash lock that uses less material.

It is still another object of the invention to provide a stamped housing that has a sweep secured to the underside of the housing.

It is a further object of the invention to provide a sweep for a sash lock that is stamped rather than cast.

It is still a further object of the invention to provide a sweep that is secured to the underside of the housing by means of a screw.

It is still another object of the invention to provide a sash lock that is made from a stamping process and which has a sweep that is spring biased.

It is an object of the invention to provide a low cost sweep lock mechanism.

It is another object of the invention to provide a sweep lock that is made of a substantial amount of cheaper materials such as plastic and having a metal outer surface of more expensive locks.

It is also an object of the invention to provide an improved sweep lock.

It is a further object of the invention to provide a composite sweep lock.

It is a still further object of the invention to provide a composite sweep lock where a significant portion of the lock is made from a non-metal, yet the lock has a metallic look and feel.

It is another object of the present invention to provide an improved offset lock.

It is still another object of the present invention to provide an improved offset sweep lock.

### SUMMARY OF THE INVENTION

The present invention is directed to a metal or plastic sash lock or combinations thereof. More particularly, the present invention is for a stamped lock, i.e. a lock made by a stamping process. The lock of the present invention can be used with or without a keeper as a sweep lock. The lock of the present invention is made from a stamping process which forms a metal, plastic or other sheet material into the parts of the lock. In a stamped process, a thin sheet of material is shaped by, for example, a die and mandrel. The lock has a housing that has a top surface and usually at least a partial side surface extending downwardly from at least one side edge of the top surface. There may also be a second side surface extending from a second side edge of the top surface. The housing also has a pair of ends also extending from the end edges of the top surface between the two side surfaces. Thus, there is a generally at least a hollow portion under the top surface for receiving a tongue or cam. The side surfaces if present have an opening in each side surface. One opening is for the handle of the tongue or cam to extend outwardly if a user can manipulate the handle of the sweep. The second opening is for the tongue or cam itself to move from a recessed position to an extended position for securing the window. The handle on the sash locks of the present invention are not usually on the top surface of the housing, but can be secured on the bottom surface of the housing by means of a screw or other means which passes through an orifice in the sweep and which extends into a recess in the underside of the top surface. The orifice is usually threaded and can, but preferably does not, extend through the top surface. The orifice for receiving the screw is preferably in the center of the underside of the top surface.

In another embodiment, the present invention is also directed to a sweep lock that is inexpensive to produce but which has a metal outer case that many customers and window manufacturers desire and an inner housing made from a less expensive material such as plastic. The present invention also has applicability as a sash lock with a cam and a keeper.

The composite sweep lock has an inner housing core made of a relatively inexpensive yet strong material. The housing core has a movable tongue that is pivotally secured thereto. The housing core may be made of any suitable material such as a non-metallic plastic including but hot limited to a thermoplastic or thermo-setting material. The thermoplastic material can include, but is not limited to, a polymeric material, i.e. polyethylene, polypropylene, polyethylene terpthalate, nylon, etc. One material that has been found suitable is a mineral filled nylon including a glass filled nylon. The tongue may be made of the same material or a different material such as a metal stamping. Over the housing a metal outer cover may be placed. The metal cover provides the look and feel of a more substantial lock but at significantly less cost.

In an alternative embodiment, there may be an outer metal housing, an inner core of a plastic or other suitable material. Attached to the inner core is a tongue or a cam that rotates into a locking arrangement. A keeper may also be present.

In still another embodiment of the present invention, the top surface of the housing has a pair of orifices. One orifice is for receiving a screw or other means to secure the sash lock to a window. The other opening could have two functions. The first function is that it is an opening for a screw or other means to pass through and secure the housing to the window sash. The other aspect of the orifice is that when it is formed by the stamping process a portion of the material extends downwardly and acts as a rivet head or flange to secure the tongue mechanism to the underside of the housing. Thus, the sweep can be secured to the housing by the rivet head or flange, by the screw that passes through the second orifice or as discussed above, there can be an orifice on the underside of the top surface for receiving a screw or other securing means. There is also a spring that provides a force to the tongue mechanism to assist in movement of the tongue and handle.

### BRIEF DESCRIPTION OF THE DRAWINGS

FIG. 1 is a top view of the sweep lock of the present invention with the tongue recessed.

FIG. 2 is an underside view of the sweep lock of FIG. 1.

FIG. 3 is a top view of the sweep lock of FIG. 1 with the tongue extended.

FIG. 4 is an underside view of the sweep lock of FIG. 3.

FIG. 5 is a side view of the sweep lock of FIG. 3 from the tongue side.

FIG. 6 is a side view of the sweep lock of FIG. 3 from the handle side.

FIG. 7 is an underside view of the sweep lock of an alternate embodiment of the lock of the present invention.

FIG. 8 is a perspective view of the sweep lock of FIG. 7 from the tongue side.

FIG. 9 is a perspective view of the sweep lock of FIG. 7 from the handle side.

FIG. 10 is a perspective view of the sweep lock of FIG. 9 with the tongue recessed.

FIG. 11 is an exploded view of the sweep lock of FIG. 7 from the handle side.

FIG. 12 is an exploded view of the sweep lock of FIG. 11 from the opposite side.

FIG. 13 is a view of the sweep mechanism.

FIG. 14 is a top view of the composite sweep lock of the present invention.

FIG. 15 is an exploded view of the composite sweep lock.

FIG. 16 is an underside view of the composite sweep lock of FIG. 14.

FIG. 17 is an exploded view of the composite sweep lock of FIG. 16.

FIG. 18 is a cut away view of the lock of FIG. 14.

FIG. 19 is an enlarged view of the area A of FIG. 18.

### DETAILED DESCRIPTION OF THE DRAWINGS

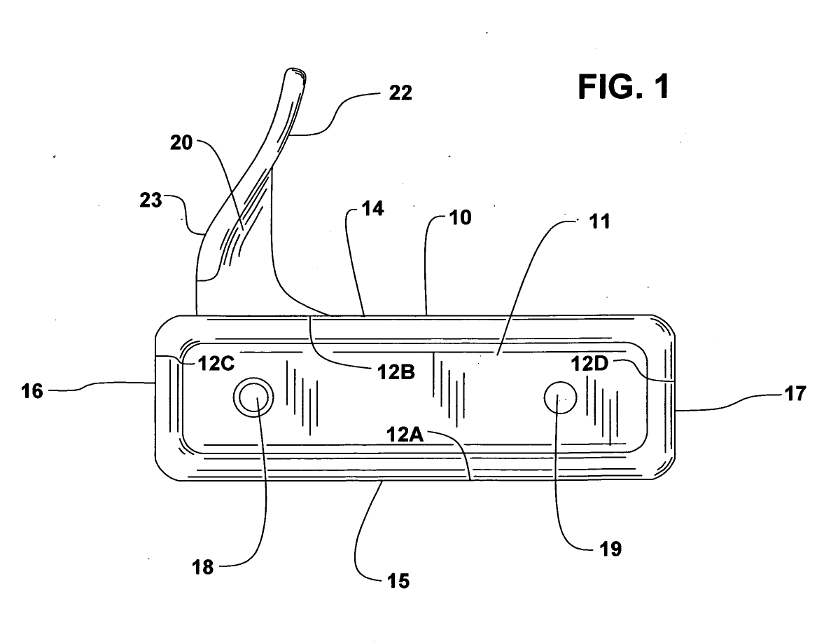

As seen in FIG. 1, the sash lock of the present invention has preferably formed from a stamped metal or plastic housing 11. Typically, the sheet of metal or plastic is placed on a die and a mandrel forces the metal or plastic into the die thereby shaping the material. The housing has a top surface 12 and a bottom surface 13. Extending from the top surface of the housing at a first side edge 12A and a second side edge 12B are a first side wall 15 and a second sidewall 14. There are also a pair of end walls 16 and 17 that extend from a first end edge 12c and a second end edge 12d. Each of the end walls extend from one sidewall to the other sidewall generally at the ends thereof.

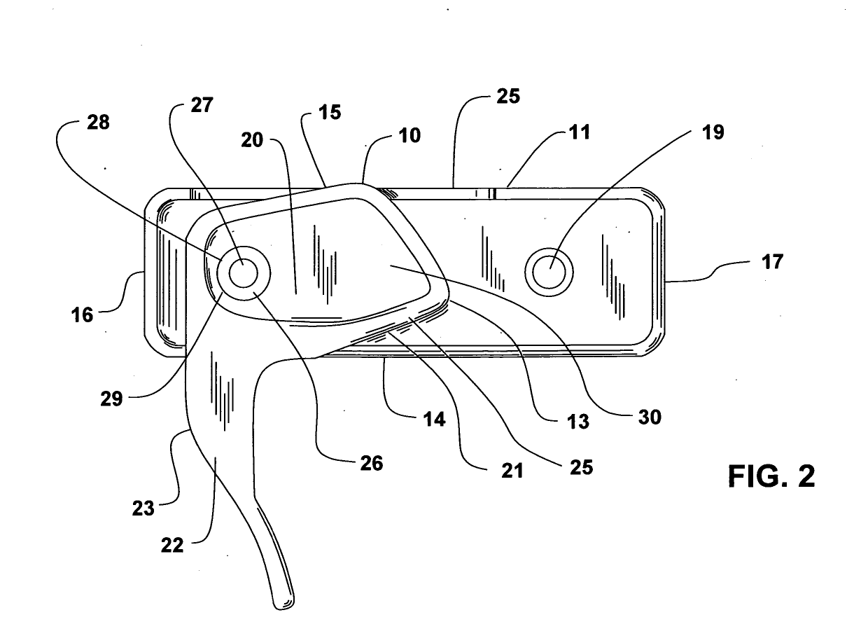

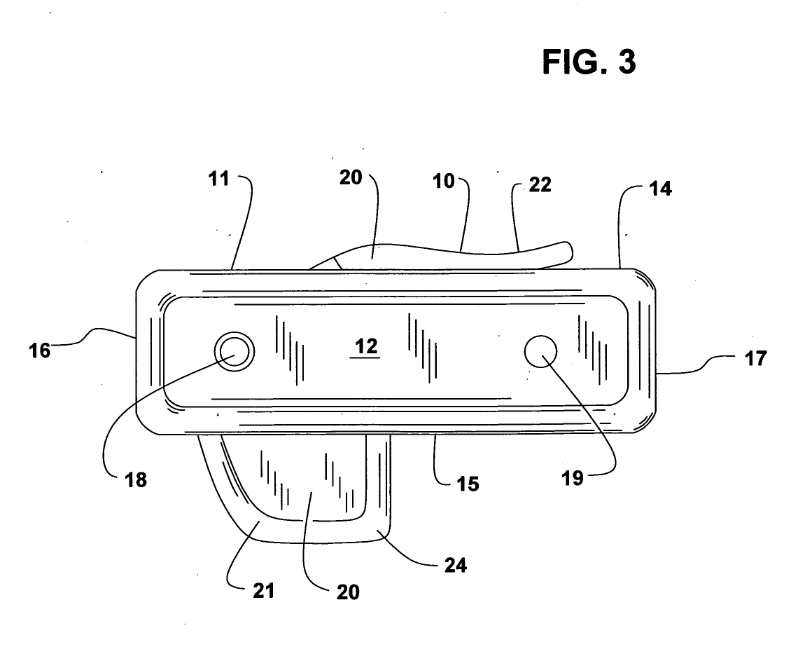

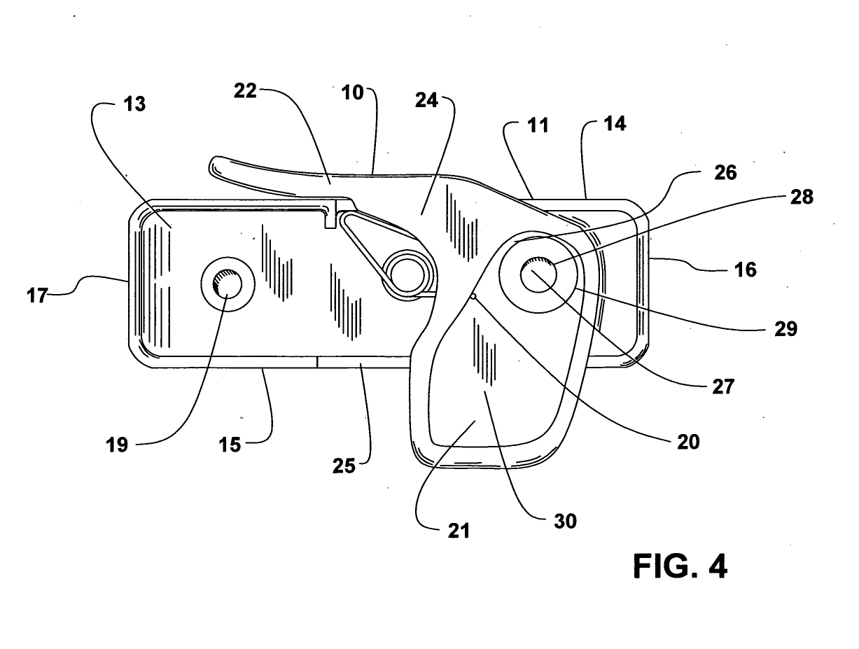

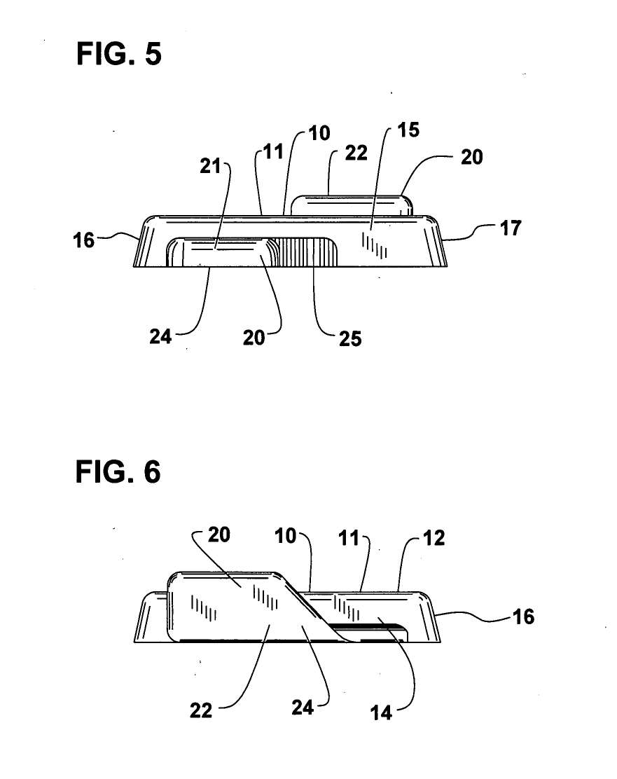

The sidewall and the end walls form an open area under the top surface 12 and adjacent the bottom surface 13 for placing the sweep 20. The sweep has a handle portion 22 and a tongue portion 21. The handle portion 22 is for manipulating the sweep. When the handle portion 22 is in a first position, the tongue portion 21 is recessed in the housing when the handle portion 22 is moved to a second position the tongue portion 21 of the sweep 20 extends outwardly. The top surface of the housing has a pair of orifices 18 and 19 that extend through the housing from the top surface 12 to the bottom surface 13. The orifices 18 and 19 usually receive screws or other means not shown which are used to secure the housing to a window sash. There is also a sweep means 20 which is secured to the underside of the housing. The sweep means 20 has a handle portion 22 and a tongue portion 21. The tongue portion 21 secures the sash of the window to, for example, a frame of the window or to another sash. As noted, the securing means can be a tongue or cam 21. On the end of the securing means opposite the tongue 21 is a handle 22. The handle 22 is used to move the tongue 21 from a first position to a second position. One of the positions is an open position 23 where the tongue is recessed. The other is a locked position with the tongue extended 24. FIGS. 1 and 2 show the configuration of the lock with the tongue in a recessed position 23. FIGS. 3 and 4 show the configuration of the lock with the tongue in an extended or locking position 24.

As seen in FIG. 2, the underside of the housing shows the sidewalls and the end walls. The sidewalls 14, 15 have an open area 25 in each of them to permit the handle 22 and the tongue 21 to pass therethrough. The securing means 20 has, in addition to the handle, a generally flat tongue 21 and transition area 26 where the handle 22 and tongue 21 are joined. The tongue can be any suitable shape to fit a respective orifice in, for example, the frame for a window sash. The transition area 26 is provided with an orifice 27. In one embodiment, through the orifice 27 passes a lip 28 that is formed when the orifice 27 is punched during the manufacturing process, usually a stamping process. The hole 27 in the securing means 20 is placed over the lip 28 and the lip edge 29 is riveted down or folded over the adjacent the bottom surface of the securing means 30 to form a flange to hold the securing means 20 in position on the underside of the housing 11. Alternatively, the lip may be provided with threads on the outer surface thereof and the securing means can be held in place by a nut instead of a flange or rivet type head. In still a further embodiment, the sweep may be secured by the screw or other means that passes through the orifice to secure the housing to the window sash.

As seen in FIG. 3, the tongue 21 is in an extended position 24 and the handle 22 has been moved from the position shown in FIG. 1 and 2 where the handle was generally perpendicular to the housing. In FIG. 3 and 4, the handle is generally adjacent to the sidewall 14 of the housing 11.

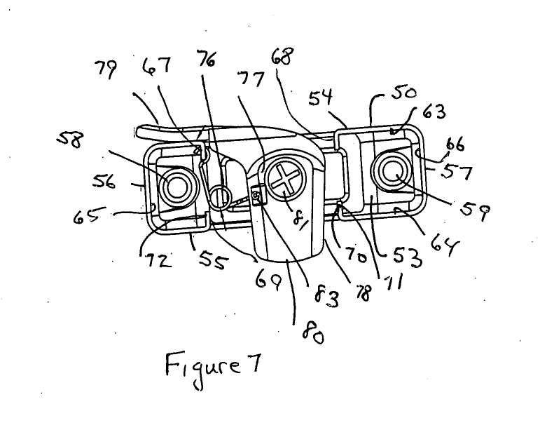

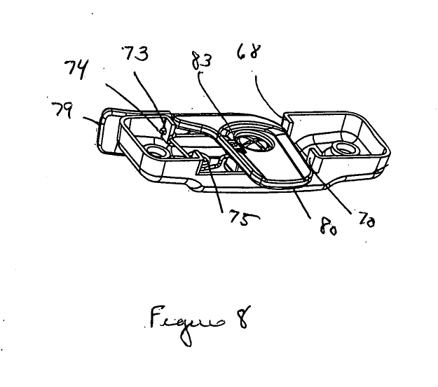

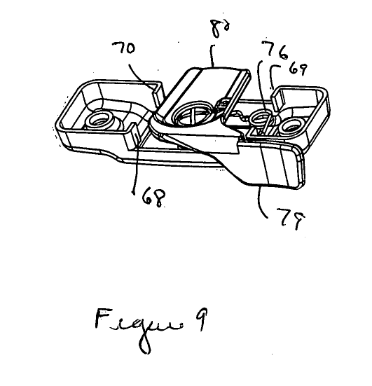

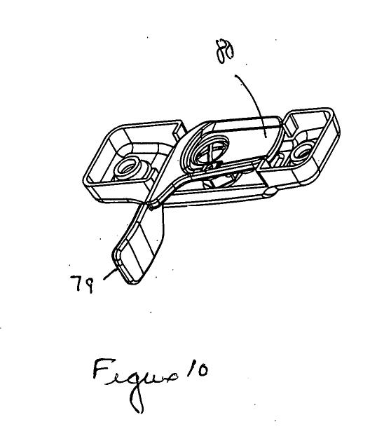

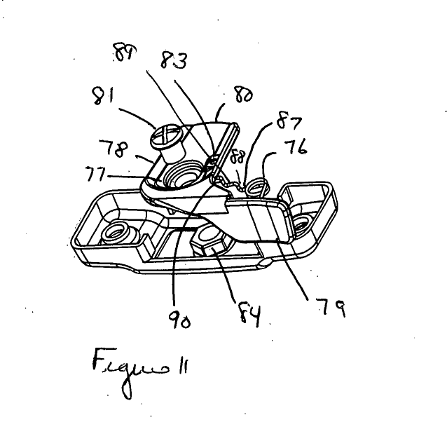

An alternative embodiment of the present invention is shown in FIGS. 7 to 13. As seen in FIG. 7, there is a sweep lock with a housing 50. The housing 50 has a top surface and a bottom surface 53. The top surface has two side walls 54 and 55, as well as two ends 56 and 57. Walls 54 and 55 extend downwardly from the top surface of the housing. In addition, end walls 56 and 57 extend from the top surface. The housing is preferably formed by stamping and the sweep lock of the present invention may be formed by stamping metal, plastic or other suitable materials. The top surface is provided with first 58 and second 59 orifices for receiving a screw or other suitable means for securing the sweep lock to a sash or other device.

FIG. 8 shows the underside of the sweep lock of the present invention. There is the bottom surface 53 that forms a recess portion in the housing. This recessed portion is formed by inner side walls 63 and 64 as well as end walls 65 and 66. Extending into the recessed portion 62 are center wall portion 67, 68, 69 and 70. These center wall portions extend from the sidewalls a short distance into the recess portion. These center wall portions can provide strength to the stamped housing. The center wall portions may be formed from portions of the sidewalls that have been bent inwardly generally perpendicularly to the sidewalls.

The center wall portions have a bottom edge 71, a top edge and a side edge 72. The center wall portions may be formed by cutting a slit generally parallel to the top surface of the housing in a portion of the sidewalls 54 and 55. The center wall portions can then be bent inwardly toward each other. In a preferred embodiment, the opposing center wall portions are generally in the same plane but preferably separated from each other. Where the edge of the tongue is curved, the center wall portions near the tongue when the tongue is retracted can be angled to better receive the tongue in the housing.

In one of the center wall portions, there is an orifice 73 for receiving one end 74 of a spring 75. The other end of the spring 76 is in an orifice 83 in the center portion 77 of the sweep 78. The sweep 78 has a handle portion 79 and a tongue portion 80. The handle 79 can move from a first portion where the tongue 80 is retracted into the housing. As the handle portion 79 moves to a second position, the tongue 80 extends outwardly. The bottom surface of the housing may be provided with a means such as a nut having a threaded orifice 84 for receiving a pin or threaded screw 81 that passes through an orifice 82 in the center portion 77 of the sweep. The screw may be provided with a head that receives a suitable screwdriver for assembly of the device.

The spring 76 is preferably a coiled spring with one or more coils in a center portion thereof. The arms 85 and 86 of the spring 76 are preferably generally at about at least a 90° angle to each other.

The end of the arm 85 of the spring 76 is preferably provided with a hook 87 that passes through the orifice 73 in the center wall portion. The other arm 86 may have a first leg 87, a first angled transition region 88, a second leg 89 and a second angled portion 90 similar to the angle of the first transition region from the end of the second leg to the end of the arm 91 of the spring 76.

The housing and the sweep of the present invention are formed by stamping integral steel plate or other suitable material. The nut is welded onto the housing. During assembly, the lever, i.e. sweep, is fastened by a screw. The lever rotates with axle of the screw. One end of the torsional spring is placed onto the housing, the other end onto the lever. Tactile operation feeling of the lock is available thanks to resilient force occurred by compressing the torsional spring. In operation, when a user actuates the lever from unlocked position, the spring, which is compressed during the lever moving form 0-degree to 45-degree, biases the lever to 90-degree by releasing its resilient force, locked. The same working principle for operation from locked to unlocked positions. The sidewall and/or a center wall portion can act as a stop to restrict the sweep when it reaches to the locked and unlocked position.

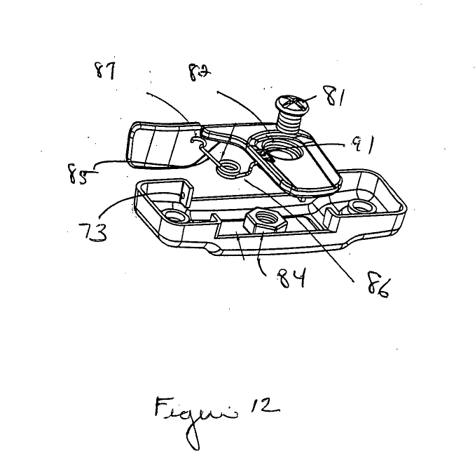

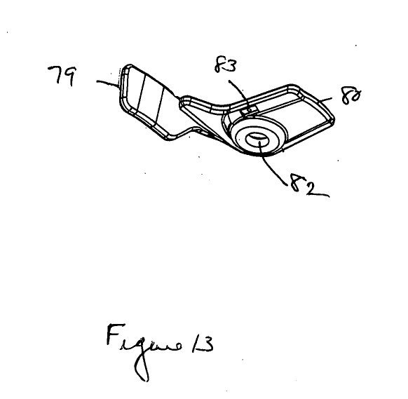

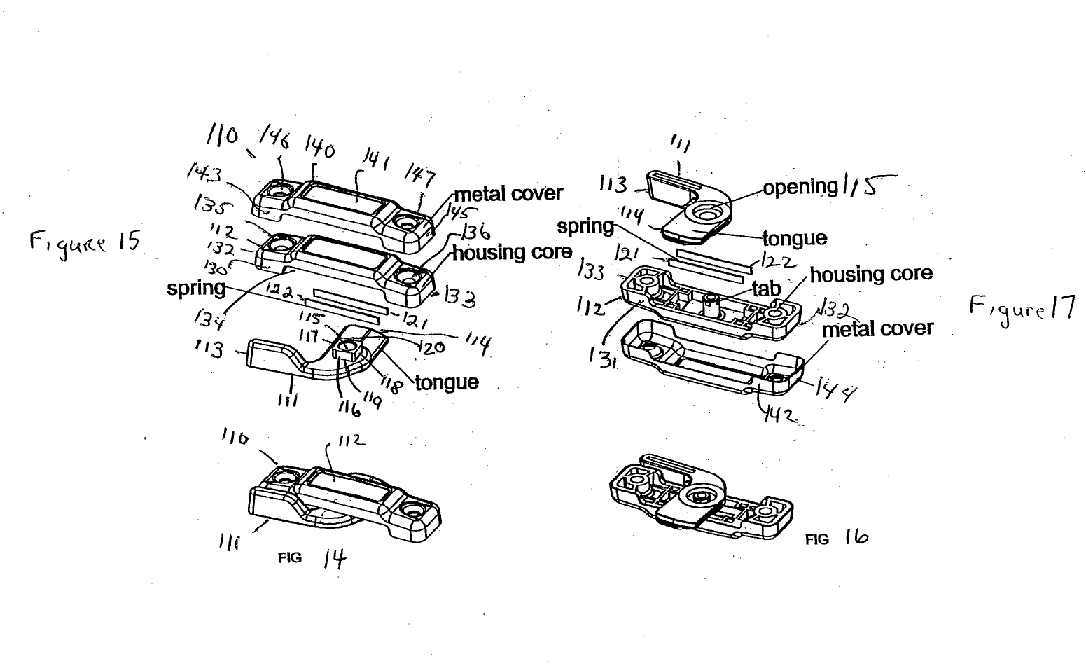

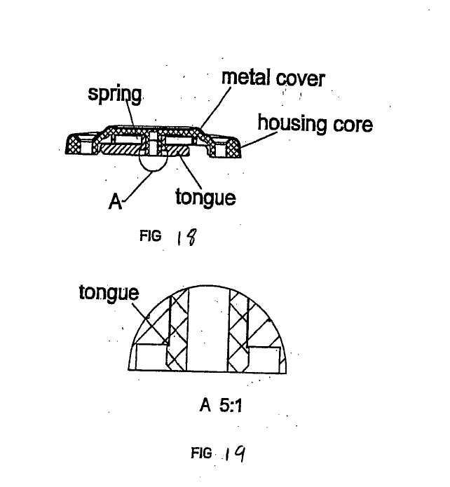

FIG. 14 shows a composite sweep lock 110 having a movable tongue 111 and a housing 112 that supports the tongue. The tongue 111 has a handle 113 and a tongue portion 114. The handle 113 permits the user to move the tongue from an open position to a locking position. The tongue 111 has an opening 115 through its surface for a rivet or screw to secure the tongue to the housing 112. The tongue 111 may be provided with a ring 116 that on its top surface surrounds the opening 115. The ring 116 has an outer surface that is preferably straight on two opposite sides 117 and 118 and straight or curved on the other two opposite sides 119 and 120. This arrangement provides a detent for the tongue when it moves from one position to the other. On two opposite sides of the tongue there are first and second leaf springs 121 and 122. These springs are a thin strip of metal that is held in position on the underside of the housing 112. When the tongue is in one position, either open or locked, the springs 121 and 122 are adjacent to the flat surfaces on the ring 117 and 118. When the tongue 111 moves to the second position, the curved portions of the ring 119 and 120 move along the spring until the opposite straight portion is reached.

As noted above, the tongue 111 is secured to the housing so that the tongue can pivot from one position to the other. The housing 112 may be made of a plastic material such as a thermoplastic or thermo-setting material. The plastic material can be any one of the common plastics used in the industry or blends thereof. It has been found that glass filled nylon is a suitable material as it combines relatively low cost with strength. The tongue can be a metal casting or more preferably made of a stamped metal. The tongue may also be made of a suitable plastic material.

The housing 112 can be any shape desired. Typically, the housing will have a generally rectangular shape with a pair of side walls 130 and 131 and opposite end walls 132 and 133. The side walls have an open area 134 for receiving the tongue and to permit the tongue to move from a first position to a second position. A pair of orifices 135 and 136 are provided in the top surface and which extend through the housing so that the housing may be secured to a surface.

The housing 112 is provided with a metal cover 140 that preferably conforms in shape to the housing. This metal cover 140 has a top surface 141 and a pair of sidewalls 142 and 143 extending from the top surface. There are also a pair of end walls 144 and 145. The contour of the metal cover preferably conforms to the shape of the housing core. There are a pair of orifices 146 and 147 that are for securing the cover to the window.

When the metal cover is positioned over the housing, the holes in the metal cover are aligned with the holes in the housing so that one pair of screws or other means may secure the composite lock to the surface. The metal cover may be made by casting or more preferably by metal stamping. A stamped metal can be made more quickly than a cast metal.

FIG. 16 shows the underside of the lock of the present invention with the tongue in an extended position. FIG. 17 shows an exploded view of underside of the lock. FIG. 18 shows a side cutaway view of the lock of FIG. 14 taken through the center of the assembly. FIG. 19 shows an enlargement of the region A of FIG. 18.

In a preferred embodiment, the housing core has sloping sidewalls so that the base of the housing core has a larger surface area than the top of the housing core. This permits the cover to be easily removed. While the housing core and the cover are shown with a generally flat surface it will be appreciated that other configurations are possible. The metal cover is preferably made from a metal material although other materials may be used as well. The cover is preferably a thin material that may be stamped to form the cover. This provides significant benefits over cast metal lock housings as the stamped material does not need to cool down before it can be worked to for the lock.

The housing core may be any suitable material including but not limited to a thermoplastic or thermo-setting material. The thermoplastic material can include, but is not limited to, a polymeric material, i.e. polyethylene, polypropylene, polyethylene terpthalate, nylon, etc. One material that has been found suitable is a mineral filled nylon including a glass filled nylon. The tongue may be made of the same material or a different material such as a metal stamping.

We claim:

1. A sweep lock having a housing, said housing having a top surface, a bottom surface, first and second sidewalls extending from opposite sides of the top surface, said top surface also having first and second end walls extending from said top surface, said end walls extending from one sidewall to the opposite sidewall;
said bottom surface of said housing having a sweep connected thereto, said sweep having a handle portion and a tongue portion, said sweep being adapted to move from a first position to a second position, whereby said tongue is in an extended position in one of said first and second positions;
said housing having spring means having a first end and a second end, said first end being secured to said housing, said second end being secured to said sweep.

2. The sweep lock according to claim 1, wherein there is at least one center wall portion extending into a recess formed by said sidewalls, end walls and bottom surface.

3. The sweep lock according to claim 1, wherein said center wall portion has an orifice for receiving an end of said spring.

4. The sweep lock according to claim 3 wherein said sweep has a center portion between said tongue portion and said handle portion and wherein said center portion has an orifice for receiving an end of said spring.

5. The sweep lock according to claim 1 wherein said housing is made by stamping a sheet material.

6. The sweep lock according to claim 1 wherein said sweep is formed by stamping a sheet material.

7. The sweep lock according to claim 4 wherein said spring is a coil spring.

8. The sweep lock according to claim 7 wherein said spring has a generally circular hook on an end that is secured to said center wall portion.

9. The sweep lock according to claim 7 wherein said end of said spring that passes into said orifice in said sweep has at least a first leg and a second leg and wherein said first leg and said second leg are generally parallel to each other.

10. The sweep lock according to claim 9 wherein there is an angled transition region between said first leg and said second leg.

11. The sweep lock according to claim 9 wherein the portion of said spring from said second leg to an end of said arm is generally perpendicular to said second leg.

12. The sweep lock according to claim 9 wherein the portion of said spring from said second leg to an end of said arm is generally perpendicular to a top surface of said housing.

13. The sweep lock according to claim 9 wherein the portion of said spring from said second leg to an end of said arm is generally perpendicular to a top surface of said sweep.

14. The sweep lock according to claim 1 wherein a nut is secured to said inside surface of said housing.

15. The sweep lock according to claim 14 wherein said nut is threaded and receives a screw for securing said sweep to said housing.

16. The sweep lock according to claim 14 wherein said nut is welded to the inner surface of said housing.
